(19) United States
(12) Patent Application Publication
(10) Pub. No.: US 2023/0014982 A1
(43) Pub. Date: Jan. 19, 2023

(54) Cargo Trailer Ladder Assembly

(71) Applicant: Tanya Florence, Forney, TX (US)

(72) Inventor: Tanya Florence, Forney, TX (US)

(21) Appl. No.: 17/375,826

(22) Filed: Jul. 14, 2021

(51) Int. Cl. B60R 3/00; E06C 7/46; E06C 7/48; E06C 7/00

(52) U.S. Cl. CPC B60R 3/007; E06C 7/46; E06C 7/48; E06C 7/00; B60P 7/15

(57) ABSTRACT

A cargo trailer ladder assembly for safely entering or exiting a cargo trailer includes a pair of load locks that is each extendable between walls of a cargo trailer for securing cargo in the cargo trailer. A ladder is included that has a plurality of engagement points thereon. Each of the load locks is positionable in respective ones of the engagement points for storing the load locks with the ladder. The ladder is positionable to engage the cargo trailer to facilitate a user to safely climb into or out of the cargo trailer. A strap is removably coupled to the ladder and the strap can be slung over the user's shoulder for carrying the ladder.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ladder devices and more particularly pertains to a new ladder device for safely entering or exiting a cargo trailer.

### (2) Description of Related Art Including Information Disclosed Under 37 CFR 1.97 and 1.98

The prior art relates to ladder devices. The prior art discloses a variety of ladders that are each attachable to a cargo trailer for entering or exiting the cargo trailer. Each of the ladders disclosed in the prior art includes novel attachment elements for attaching the ladder to the cargo trailer. None of the prior art cited includes load locks or a means of attaching the load locks to a ladder.

### BRIEF SUMMARY OF THE INVENTION

An embodiment of the disclosure meets the needs presented above by generally comprising a pair of load locks that is each extendable between walls of a cargo trailer for securing cargo in the cargo trailer. A ladder is included that has a plurality of engagement points thereon. Each of the load locks is positionable in respective ones of the engagement points for storing the load locks with the ladder. The ladder is positionable to engage the cargo trailer to facilitate a user to safely climb into or out of the cargo trailer. A strap is removably coupled to the ladder and the strap can be slung over the user's shoulder for carrying the ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a cargo trailer ladder assembly according to an embodiment of the disclosure.

FIG. 2 is a right side view of an embodiment of the disclosure.

FIG. 3 is a back view of an embodiment of the disclosure showing a pair of load locks being attached to a ladder.

FIG. 4 is a right view of an embodiment of the disclosure showing a pair of load locks being attached to a ladder.

FIG. 5 is a detail view taken from circle 5 of FIG. 1 of an embodiment of the disclosure.

### DETAILED DESCRIPTION OF THE INVENTION

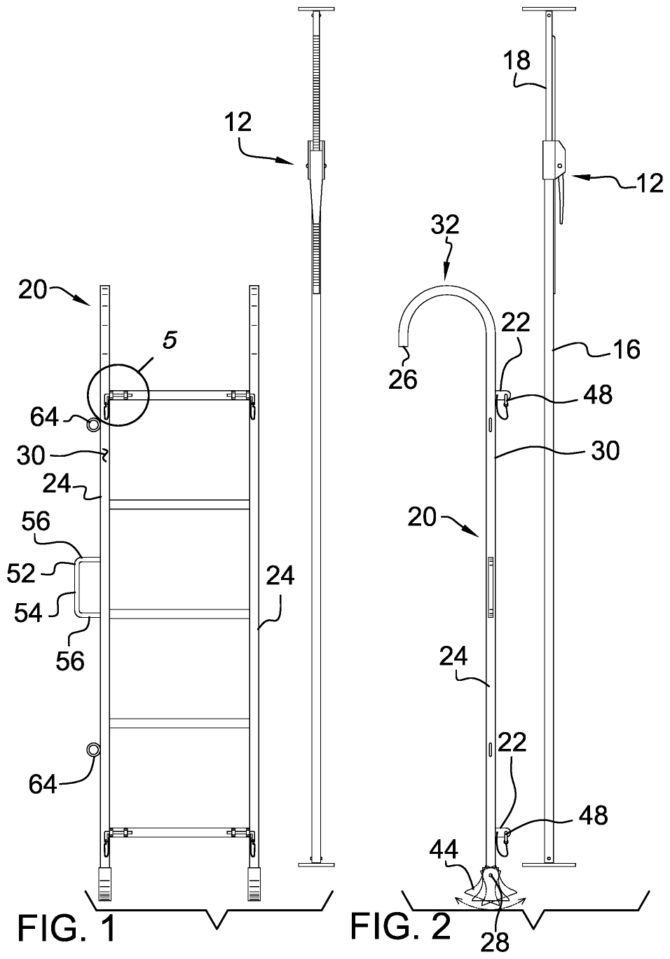

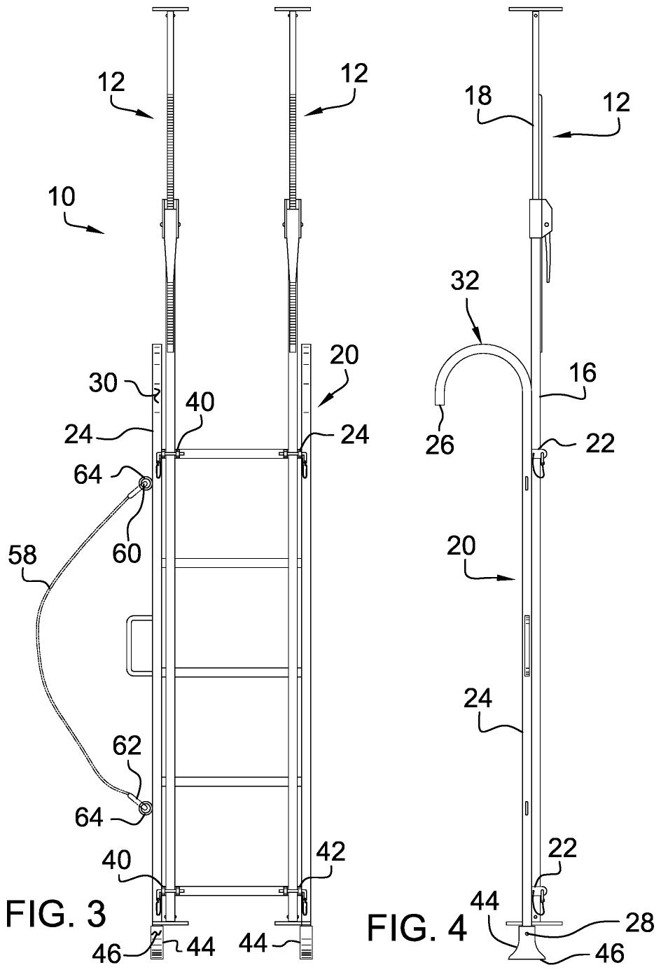

With reference now to the drawings, and in particular to FIGS. 1 through 5 thereof, a new ladder device embodying the principles and concepts of an embodiment of the disclosure and generally designated by the reference numeral 10 will be described.

As best illustrated in FIGS. 1 through 5, the cargo trailer ladder assembly 10 generally comprises a pair of load locks 12 that is each extendable between walls of a cargo trailer for securing cargo in the cargo trailer. The cargo trailer may be an enclosed semi trailer, a box of a cargo truck or any other similar type of cargo trailer. Each of the load locks 12 may comprise a first pole 16 insertably receiving a second pole 18 such that the load locks 12 have a telescopically adjustable length. Moreover, each of the load locks 12 may comprise extendable load locks of any conventional design that are commonly employed by semi truck drivers.

A ladder 20 is included and the ladder 20 has a plurality of engagement points 22 thereon. Each of the load locks 12 is positionable in respective ones of the engagement points 22 for storing the load locks 12 with the ladder 20. In this way the load locks 12 and the ladder 20 can be removably attached to the cargo trailer at a preferred location for storage. Additionally, the ladder 20 is positionable to engage the cargo trailer to facilitate a user to safely climb into or out of the cargo trailer. In this way the user can enter the cargo trailer to install the load locks 12 with minimal risk of falling.

The ladder 20 has a pair of legs 24 and each of the legs 24 has a top end 26, a bottom end 28 and a first surface 30 extending therebetween. Each of the legs 24 is curved adjacent to the top end 26 such that the top end 26 is directed toward the bottom end 28 thereby defining a hook portion 32 on each of the legs 24. The hook portion 32 is positionable over a structural feature of the cargo trailer for securing the ladder 20 to the cargo trailer having the bottom end 28 of each of the legs 24 abutting the ground. The structural feature may be a stepping bar on the cargo trailer, a rear edge of the cargo trailer or any other suitable structural feature that is near the entry way of the cargo trailer. Additionally, each of the legs 24 of the ladder 20 has a length that is sufficient to extend between a floor of a typical semi cargo trailer and the ground.

Each of the engagement points 22 comprises a pair of tabs 36 that are each coupled to and extend away from the first surface 30 of a respective one of the legs 24. Each of the tabs 36 has an opening 38 extending therethrough. The tabs 36 are spaced apart from each other a sufficient distance to have a respective one of the load locks 12 positioned therebetween. Additionally, the plurality of engagement points 22 includes a set of first engagement points 40 and a set of second engagement points 42. Each of the first engagement points 40 is positioned on a respective one of the legs 24 and the first engagement points 40 are spaced apart from each other. Each of the second engagement points 42 is positioned on a respective one of the legs 24 and each of the second engagement points 42 is aligned with a respective one of the first engagement points 40.

A pair of feet 44 is included and each of the feet 44 is pivotally coupled to the bottom end 28 of a respective one of the legs 24. Each of the feet 44 has a resting surface 46 that is positionable at a variety of angles with respect to an axis extending through the top end 26 and the bottom end 28 of the respective leg 24. In this way the ladder 20 is facilitated to be stable when the ladder 20 is positioned at an angle.

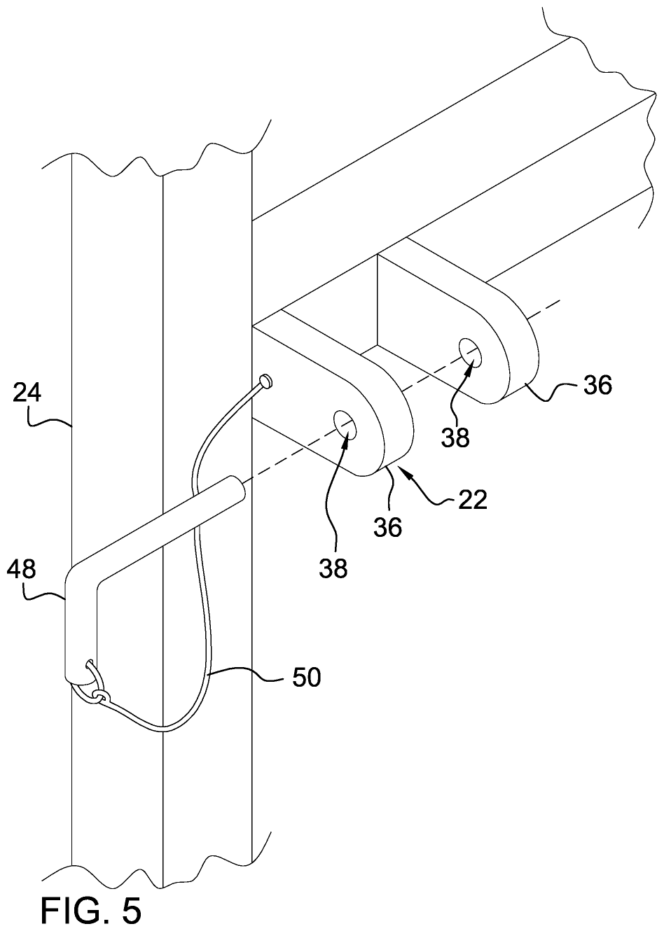

A plurality of pins 48 is provided and each of the pins 48 is extendable through the opening 38 in each of the tabs 36 of a respective one of the engagement points 22 when the respective load lock 12 is positioned between the tabs 36. Additionally, the pins 48 extend over the respective load lock 12 to retain the respective load lock 12 between the tabs 36. As is most clearly shown in FIG. 5, a cable 50 or other similar device may be coupled between each of the pins 48 and the ladder 20 to inhibit the pins 48 from being lost.

A handle 52 is coupled to a respective one of the legs 24 of the ladder 20 for carrying the ladder 20. The handle 52 comprises a central member 54 extending between a pair of end members 56. Each of the end members 56 is coupled to and extends laterally away from the respective leg on which the handle 52 is positioned having the central member 54 being spaced from the ladder 20. A strap 58 is removably coupled to the ladder 20 and the strap 58 can be slung over the user's shoulder for carrying the ladder 20. The strap 58 has a primary end 60 and a secondary end 62, and each of the primary end 60 and the secondary end 62 is removably attachable to a respective connection point 64 on a respective one of the legs 24.

In use, each of the load locks 12 is positioned in respective engagement points 22 for storing the load locks 12 with the ladder 20 on the cargo trailer. The ladder 20 and the load locks 12 are carried to the rear of the trailer 14, the load locks 12 are removed from the engagement points 22 and the load locks 12 are placed in the trailer 14. The hook portion 32 on each of the legs 24 of the ladder 20 is positioned on the cargo trailer and the user climbs the ladder 20 to enter the cargo trailer. In this way the user can safely enter or exit the cargo trailer with minimum risk of injury due to falling from the cargo trailer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cargo trailer ladder assembly being configured to be removably coupled to a cargo trailer thereby facilitating a user to safely climb into and out of the cargo trailer, said assembly comprising:
a pair of load locks, each of said load locks being extendable between walls of a cargo trailer for securing cargo in the cargo trailer, each of said load locks comprising a first pole insertably receiving a second pole such that said load locks have a telescopically adjustable length;
a ladder having a plurality of engagement points thereon, each of said load locks being positionable in respective ones of said engagement points for storing said load locks with said ladder, said ladder being positionable to engage the cargo trailer wherein said ladder is configured to facilitate a user to safely climb into or out of the cargo trailer;
a handle being coupled to a respective one of said legs of said ladder for carrying said ladder; and
a strap being removably coupled to said ladder wherein said strap is configured to be slung over the user's shoulder for carrying said ladder.

2. The assembly according to claim 1, wherein said ladder has a pair of legs, each of said legs having a top end, a bottom end and a first surface extending therebetween, each of said legs being curved adjacent to said top end such that said top end is directed toward said bottom end thereby defining a hook portion on each of said legs, said hook portion being positionable over a structural feature of the cargo trailer for securing said ladder to the cargo trailer having said bottom end of each of said legs abutting the ground.

3. The assembly according to claim 2, wherein each of said engagement points comprises a pair of tabs that are each coupled to and extend away from said first surface of a respective one of said legs, each of said tabs having an opening extending therethrough, said tabs being spaced apart from each other a sufficient distance to have a respective one of said load locks positioned therebetween.

4. The assembly according to claim 3, wherein said plurality of engagement points includes a set of first engagement points and a set of second engagement points, each of said first engagement points being positioned on a respective one of said legs, said first engagement points being spaced apart from each other, each of said second engagement points being positioned on a respective one of said legs, each of said second engagement points being aligned with a respective one of said first engagement points.

5. The assembly according to claim 2, further comprising a pair of feet, each of said feet being pivotally coupled to said bottom end of a respective one of said legs, each of said feet having a resting surface being positionable at a variety of angles with respect to an axis extending through said top end and said bottom end of said respective leg thereby facilitating said ladder to be stable at an angle.

6. The assembly according to claim 4, further comprising a plurality of pins, each of said pins being extendable through said opening in each of said tabs of a respective one of said engagement points when said respective load lock is positioned between said tabs, said pin extending over said respective load lock to retain said respective load lock between said tabs.

7. The assembly according to claim 2, wherein said handle comprises a central member extending between a pair of end members, each of said end members being coupled to and extending laterally away from said respective leg on which said handle is positioned having said central member being spaced from said ladder.

8. The assembly according to claim 2, wherein said strap has a primary end and a secondary end, each of said primary end and said secondary end being removably attachable to a respective connection point on a respective one of said legs.

9. A cargo trailer ladder assembly being configured to be removably coupled to a cargo trailer thereby facilitating a user to safely climb into and out of the cargo trailer, said assembly comprising:
a pair of load locks, each of said load locks being extendable between walls of a cargo trailer for securing cargo in the cargo trailer, each of said load locks comprising a first pole insertably receiving a second pole such that said load locks have a telescopically adjustable length;
a ladder having a plurality of engagement points thereon, each of said load locks being positionable in respective ones of said engagement points for storing said load locks with said ladder, said ladder being positionable to engage the cargo trailer wherein said ladder is configured to facilitate a user to safely climb into or out of the cargo trailer, said ladder having a pair of legs, each of said legs having a top end, a bottom end and a first surface extending therebetween, each of said legs being curved adjacent to said top end such that said top end is directed toward said bottom end thereby defining a hook portion on each of said legs, said hook portion being positionable over a structural feature of the cargo trailer for securing said ladder to the cargo trailer having said bottom end of each of said legs abutting the ground, each of said engagement points comprising a pair of tabs that are each coupled to and extend away from said first surface of a respective one of said legs, each of said tabs having an opening extending therethrough, said tabs being spaced apart from each other a sufficient distance to have a respective one of said load locks positioned therebetween, said plurality of engagement points including a set of first engagement points and a set of second engagement points, each of said first engagement points being positioned on a respective one of said legs, said first engagement points being spaced apart from each other, each of said second engagement points being positioned on a respective one of said legs, each of said second engagement points being aligned with a respective one of said first engagement points;
a pair of feet, each of said feet being pivotally coupled to said bottom end of a respective one of said legs, each of said feet having a resting surface being positionable at a variety of angles with respect to an axis extending through said top end and said bottom end of said respective leg thereby facilitating said ladder to be stable at an angle;
a plurality of pins, each of said pins being extendable through said opening in each of said tabs of a respective one of said engagement points when said respective load lock is positioned between said tabs, said pin extending over said respective load lock to retain said respective load lock between said tabs;
a handle being coupled to a respective one of said legs of said ladder for carrying said ladder, said handle comprising a central member extending between a pair of end members, each of said end members being coupled to and extending laterally away from said respective leg on which said handle is positioned having said central member being spaced from said ladder; and
a strap being removably coupled to said ladder wherein said strap is configured to be slung over the user's shoulder for carrying said ladder, said strap having a primary end and a secondary end, each of said primary end and said secondary end being removably attachable to a respective connection point on a respective one of said legs.
